(19) United States
(12) Patent Application Publication
(10) Pub. No.: US 2025/0119819 A1
(43) Pub. Date: Apr. 10, 2025

(54) MULTI-ACCESS POINT COORDINATION CONFIGURATION PROTOCOL

(71) Applicant: Cisco Technology, Inc., San Jose, CA (US)

(72) Inventors: Juan Carlos Zuniga, Montreal (CA); Malcolm M. Smith, Richardson, TX (US); Brian D. Hart, Sunnyvale, CA (US); Jerome Henry, Pittsboro, NC (US)

(73) Assignee: Cisco Technology, Inc., San Jose, CA (US)

(21) Appl. No.: 18/483,601

(22) Filed: Oct. 10, 2023

Related U.S. Application Data
(60) Provisional application No. 63/501,911, filed on May 12, 2023.

(51) Int. Cl. H04W 48/16; H04W 88/10

(52) U.S. Cl. CPC H04W 48/16; H04W 88/10

(57) ABSTRACT

Multi-AP Coordination (MAPC) configuration protocol may be provided. MAPC modes supported by a plurality of Access Points (APs) may be discovered. A MAPC group of a sub-set of APs of the plurality of APs may be formed. Each AP of the sub-set of APs of the MAPC group may support at least one common MAPC mode. Roles including a leader and followers of the MAPC group may be advertised. A first AP of the MAPC group may be assigned as the leader and remaining APs of the MAPC group may be assigned as the followers.

### RELATED APPLICATION

Under provisions of 35 U.S.C. § 119(e), Applicant claims the benefit of U.S. Provisional Application No. 63/501,911, filed May 12, 2023, which is incorporated herein by reference.

### TECHNICAL FIELD

The present disclosure relates generally to providing Access Point (AP) coordination and specifically to providing Multi-AP Coordination (MAPC) configuration protocol.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Multi-Access Point Coordination (MAPC) configuration protocol;

FIG. 2 is a flow chart of a method for providing MAPC configuration protocol; and

FIG. 3 is a block diagram of a computing device.

### DETAILED DESCRIPTION

### Overview

Multi-Access Point Coordination (MAPC) configuration protocol may be provided. MAPC modes supported by a plurality of Access Points (APs) may be discovered. A MAPC group of a sub-set of APs of the plurality of APs may be formed. Each AP of the sub-set of APs of the MAPC group may support at least one common MAPC mode. Roles including a leader and followers of the MAPC group may be advertised. A first AP of the MAPC group may be assigned as the leader and remaining APs of the MAPC group may be assigned as the followers.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In the Institute of Electrical and Electronics Engineers (IEEE) 802.11 be (Wi-Fi 7) and the IEEE 802.11 bn (Wi-Fi 8) standards, Multi-Access Point Coordination (MAPC) may be considered as one of the main features. MAPC may allow higher network densification and higher network performance while avoiding issues such as co-channel interference. There may be several MAPC modes of operation. MAPC modes may include, for example, Coordinated Spatial-Reuse (C-SR), Coordinated Time-Division-Multiple-Access (C-TDMA), Coordinated Frequency-Division-Multiple-Access (C-FDMA), and Coordinated Orthogonal-Frequency-Division-Multiple-Access (C-OFDMA). There may not be a mechanism to inform and configure different modes of operation across a Wireless Local Area Network (WLAN). This disclosure provides processes for MAPC configuration protocol.

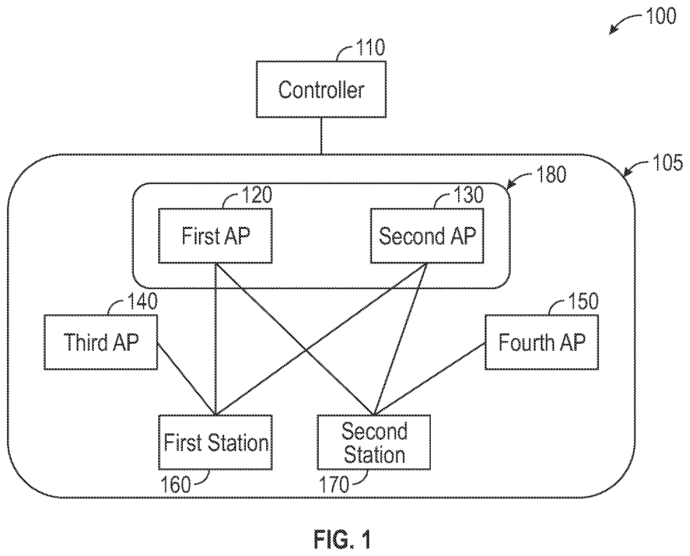

FIG. 1 is a block diagram of an operating environment 100 for MAPC configuration protocol. Operating environment 100 may include a network 105 and a controller 110. Network 105 may include a plurality of network devices, for example, a plurality of Access Points (APs) (that is, a first AP 120, a second AP 130, a third AP 140, and a fourth AP 150) and a plurality of stations (that is, a first station 160 and a second station 170. Network 105 may further include a MAPC group 180 that may include first AP 120 and second AP 130. Network 105 may be, but is not limited to, a WLAN. Network 105 may also be referred to as a coverage environment.

Controller 110 may be a WLAN controller (WLC) and may provision and control network 105. Controller 110 may be implemented by a Digital Network Architecture Center (DNAC) controller (i.e., a Software-Defined Network (SDN) controller). Controller 110, first AP 120, second AP 130, third AP 140, and fourth AP 150 may provide a WLAN. Through this WLAN, first station 160 and second station 170 may be provided with access to the Internet or other cloud-based networking environments.

Each of first AP 120, second AP 130, third AP 140, and fourth AP 150 may be compatible with specification standards such as, but not limited to, the Institute of Electrical and Electronics Engineers (IEEE) 802.11 specification standard for example. First AP 120, second AP 130, third AP 140, and fourth AP 150 may communicate with each other to conduct operations in concert. In addition, first AP 120, second AP 130, third AP 140, and fourth AP 150 may be devices that can send and receive signals to provide a connection to network 105.

First station 160 and second station 170 may communicate with one or more of first AP 120, second AP 130, third AP 140, and fourth AP 150. First station 160 and second station 170 may be, for example, an AP, a smart phone, a personal computer, a tablet device, a mobile device, a telephone, a remote control device, a set-top box, a digital video recorder, an Internet of Things (IoT) device, a cellular base station, a telephone, a remote control device, a set-top box, a digital video recorder, a cable modem, a network computer, a mainframe, a router, or other similar microcomputer-based device capable of accessing and using a Wi-Fi network.

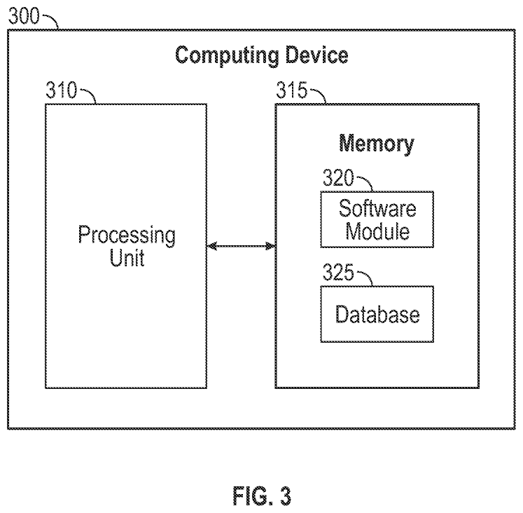

The elements described above of operating environment 100 (e.g., controller 110, first AP 120, second AP 130, third AP 140, fourth AP 150, first station 160, and second station 170) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

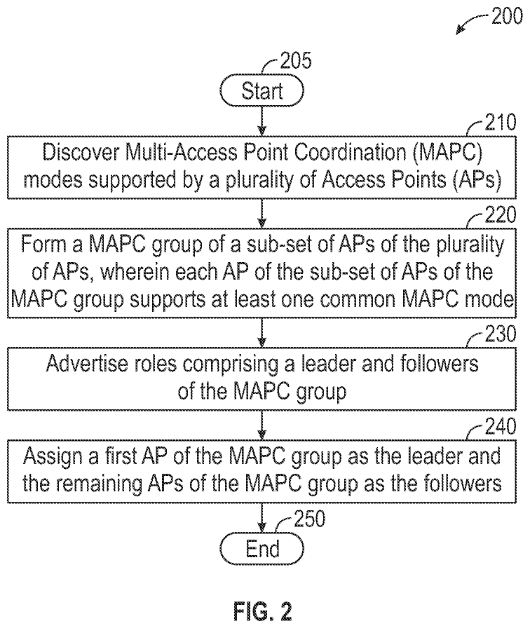

FIG. 2 is a flow chart setting forth the general stages involved in a method 200 consistent with embodiments of the disclosure for MAPC configuration protocol. Method 200 may be implemented first AP 120 as described in more detail above with respect to FIG. 1. However, method 200 may also be implemented using any of first AP 120, second AP 130, third AP 140, and fourth AP 150 as described in more detail above with respect to FIG. 1. Ways to implement the stages of method 200 will be described in greater detail below.

Method 200 may begin at starting block 205 and proceed to stage 210 where controller 110 may discover MAPC modes supported by the plurality of APs (for example, first AP 120, second AP 130, third AP 140, and fourth AP 150). Each of the plurality of APs of network 105 (that is, first AP 120, second AP 130, third AP 140, and fourth AP 150) may broadcast discovery frames comprising one or more MAPC modes supported by broadcasting AP. In some examples, controller 110 may send a request to each of the plurality of APs (for example, first AP 120, second AP 130, third AP 140, and fourth AP 150) to inquire about MAPC modes supported by them. Each of the plurality of APs (that is, first AP 120, second AP 130, third AP 140, and fourth AP 150) may then send a response comprising the one or more MAPC modes supported by responding AP. The MAPC modes may include C-SR, C-TDMA, C-FDMA, C-OFDMA, or a combination of two or more of C-SR, C-TDMA, C-FDMA, and C-OFDMA. Hybrid modes, for example, C-SR+C-TDMA or C-FR+C-OFDMA may offer higher gains in certain deployments.

Discovery frames broadcasted by the plurality of APs in network 105 may be detected by other APs which may be in a radio range of broadcasting APs. These discovery frames then may be relayed to controller 110 and other APs which are not in the radio range of broadcasting APs. The discovery frames may be relayed using a relay mechanism such as the IEEE 802.11s. In some examples, the discovery frames may be broadcasted or sent over the air using as wireless frames (for example, using the IEEE 802.11 frames). In some embodiments, the discovery frames may be sent over the wire using a Layer 2 (L2) transport, for example, the IEEE 802.3 frames. In some other embodiments, a higher layer transport protocol may be used either over the air or over the wire. The higher layer protocols may include a User Datagram Protocol (UDP), a Transmission Control Protocol (TCP), a Hypertext Transfer Protocol (HTTP), a Constrained Application Protocol (CoAP), a Quick UDP Internet Connections (QUIC), etc.

After discovering the MAPC modes supported by the plurality of APs at stage 210, method 200 may proceed to stage 220 where controller 110 may form MAPC group 180 of a sub-set of APs of the plurality of APs. Each AP of the sub-set of APs of MAPC group 180 may support at least one common MAPC mode. For example, controller 110 may determine that first AP 120 and second AP 130 both support at least one of: C-SR, C-TDMA, C-FDMA, C-OFDMA, or a combination of two or more of C-SR, C-TDMA, C-FDMA, and C-OFDMA. In response to determining that first AP 120 and second AP 130 both support at least one common MAPC mode, controller 110 may form MAPC group 180 comprising first AP 120 and second AP 130. For example, controller 110 may send instructions to each of first AP 120 and second AP 130 to form MAPC group 180. In some examples, instead of controller 110, MAPC group 180 may be formed by any AP of the plurality of APs.

Once having formed MAPC group 180 at stage 220, method 200 may proceed to stage 230 where controller 110 may advertise roles comprising a leader and followers of the MAPC group 180. Controller 110 may advertise for the roles to each member AP (that is, first AP 120 and second AP 130) of MAPC group 180. In some examples, each member APs of MAPC group 180 (that is, first AP 120 and second AP 130) may broadcast or exchange candidacy frames for electing the leader. The candidacy frames may include properties and capabilities of the sending AP. Properties may include a location of the sending AP with respect to all other member APs of MAPC group 180. Capabilities may include a processing power, a bandwidth, connectivity, etc.

After advertising the roles at stage 230, method may proceed to stage 240 where controller 110 may assign first AP 120 of MAPC group 180 as the leader and the remaining APs of MAPC group 180 (that is, second AP 130) as the follower. Controller 110 may assign the leader's role to first AP 120 based on the candidacy frames of each member AP of MAPC group 180. Controller 110, for example, may assign the leaders role to first AP 120 because first AP 120 may ideally be located to send/receive radio signals from all member APs of MAPC group 180. In some other examples, first AP 120 may be selected to be the leader because of its processing capabilities. There may be other ways to elect the leader for MAPC group 180. For example, each member APs of MAPC group 180 may in their candidacy frames announce themselves to be the leader unless another better candidate may exist in MAPC group 180. In some examples, the leader may be selected by the member APs without involvement of controller 110.

After assigning the leader role to first AP 120, and upon acceptance of the leader's role by first AP 120, controller 110 may assign remaining member APs (for example, second AP 130) as the followers. In some examples, a leader can also be a follower. In some examples, a leader's role may be assigned for each of the least one common MAPC mode based on which MAPC group 180 is formed. In such examples, there can be more than one leader in MAPC group 180. The leader's role may be assigned for a predetermined time period. After the expiry of the predetermined time period the leader's role may be reassigned or re-determined.

First AP 120 after assuming the leader's role, may configure a MAPC mode for MAPC group 180. The MAPC mode for MAPC group 180 may be one of the at least one common mode based on which MAPC group 180 may be formed. First AP 120 may instruct member APs of MAPC group 180 to use the configured MAPC mode to exchange messages or communicate with each other. In addition, first AP 120 after assuming the leader's role and configuring a MAPC mode for MAPC group 180, may distribute timing for MAPC group 180. Each member AP of MAPC group 180 may synchronize to the timing distributed by first AP 120.

First AP 120 after assuming the leader's role, may also manage resource sharing in MAPC group 180. For example, first AP 120 may assign generic resources to each member APs of MAPC group 180. In addition, first AP 120 may assign time resources, that is, a time slot for each member AP to send and receive messages. Moreover, first AP 120 may assign frequency/channel resources to each member APs to send and receive messages. Furthermore, first AP 120 may assign a duration for each resource assignment. The member APs may release the assigned resources at the end of the assigned duration.

First AP 120 after assuming the leader's role, may manage MAPC group 180. For example, first AP 120 as the leader of MAPC group 180 may remove a member AP from MAPC group 180, may join a new member AP to MAPC group 180, or may abandon MAPC group 180. For example, first AP 120 may admit a new member AP to MAPC group 180 in response to a request to join. In addition, after joining of a new member AP or removal of a member AP, the process for assigning roles and resources may be repeated.

In one embodiment, messages exchanged between member APs of MAPC group 180, between the leader (that is, first AP 120) and followers (that is, second AP 130) of MAPC group 180, between controller 110 and member APs of MAPC group 180, or between member APs and stations associated with the member APs of MAPC group 180, may be sent over the air, using as transport wireless (for example, the IEEE 802.11) frames. If the member APs are within range of each other, direct communications may be used. If they are not, a relay mechanism such as the IEEE 802.11s may be used to distribute the information. In another embodiment, the messages may be sent over the wire using a L2 transport, such as the IEEE 802.3 frames. In yet another embodiment, a higher layer transport protocol may be used to exchange messages either over the air or over the wire (for example, the UDP, the TCP, the HTTP, the CoAP, the QUIC, etc.).

FIG. 3 is a block diagram of a computing device 300. As shown in FIG. 3, computing device 300 may include a processing unit 310 and a memory unit 315. Memory unit 315 may include a software module 320 and a database 325. While executing on processing unit 310, software module 320 may perform, for example, processes providing MAPC configuration protocol described with respect to FIG. 2. Computing device 300, for example, may provide an operating environment for controller 110, first AP 120, second AP 130, third AP 140, fourth AP 150, first station 160, and second station 170, and the like. Controller 110, first AP 120, second AP 130, third AP 140, fourth AP 150, first station 160, and second station 170, and the like may operate in other environments and are not limited to computing device 300.

Computing device 300 may be implemented using an AP, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
discovering Multi-Access Point Coordination (MAPC) modes supported by a plurality of Access Points (APs);
forming a MAPC group of a sub-set of APs of the plurality of APs, wherein each AP of the sub-set of APs of the MAPC group supports at least one common MAPC mode;
advertising roles comprising a leader and followers of the MAPC group; and
assigning a first AP of the MAPC group as the leader and remaining APs of the MAPC group as the followers.

2. The method of claim 1, wherein the MAPC modes comprises: Coordinated Spatial-Reuse (C-SR), a Coordinated Time-Division-Multiple-Access (C-TDMA), Coordinated Frequency-Division-Multiple-Access (C-FDMA), Coordinated Orthogonal-Frequency-Division-Multiple-Access (C-OFDMA), or a combination of two or more of C-SR, C-TDMA, C-FDMA, and C-OFDMA.

3. The method of claim 1, wherein discovering the MAPC modes comprises:
receiving a broadcast of discovery frames from each of the plurality of APs, the discovery frames comprising one or more MAPC modes supported by broadcasting AP.

4. The method of claim 1, further comprising:
receiving an acceptance from the first AP to be the leader of the MAPC group.

5. The method of claim 1, further comprising:
setting the at least one common MAPC mode as a MAPC mode of communication for the MAPC group.

6. The method of claim 5, further comprising:
distributing, after setting the MAPC mode of communication for the MAPC group, timing for the MAPC group to each AP of the MAPC group.

7. The method of claim 5, further comprising:
assigning, after setting the MAPC mode of communication for the MAPC group, resources to each AP of the MAPC group.

8. The method of claim 7, wherein assigning the resources comprises:
assigning time resources;
assigning frequency/channel resources; and
assigning a duration of the resource assignments.

9. A system comprising:
a memory storage; and
a processing unit coupled to the memory storage, wherein the processing unit is operative to:
discover Multi-Access Point Coordination (MAPC) modes supported by a plurality of Access Points (APs);
form a MAPC group of a sub-set of APs of the plurality of APs, wherein each AP of the sub-set of APs of the MAPC group supports at least one common MAPC mode;
advertise roles comprising a leader and followers of the MAPC group; and
assign a first AP of the MAPC group as the leader and remaining APs of the MAPC group as the followers.

10. The system of claim 9, wherein the MAPC modes comprises: Coordinated Spatial-Reuse (C-SR), a Coordinated Time-Division-Multiple-Access (C-TDMA), Coordinated Frequency-Division-Multiple-Access (C-FDMA), Coordinated Orthogonal-Frequency-Division-Multiple-Access (C-OFDMA), or a combination of two or more of C-SR, C-TDMA, C-FDMA, and C-OFDMA.

11. The system of claim 9, wherein the processing unit being operative to discover the MAPC modes comprises the processing unit being operative to:
receive a broadcast of discovery frames from each of the plurality of APs, the discovery frames comprising one or more MAPC modes supported by broadcasting AP.

12. The system of claim 9, wherein the processing unit is further operative to:
set the at least one common MAPC mode as a MAPC mode of communication for the MAPC group.

13. The system of claim 12, wherein the processing unit is further operative to:
distribute, after setting the MAPC mode of communication for the MAPC group, timing for the MAPC group to each AP of the MAPC group.

14. The system of claim 12, wherein the processing unit is further operative to:
assign, after setting the MAPC mode of communication for the MAPC group, resources to each AP of the MAPC group.

15. A non-transitory computer-readable medium that stores a set of instructions which when executed perform a method executed by the set of instructions comprising:
discovering Multi-Access Point Coordination (MAPC) modes supported by a plurality of Access Points (APs);
forming a MAPC group of a sub-set of APs of the plurality of APs, wherein each AP of the sub-set of APs of the MAPC group supports at least one common MAPC mode;
advertising roles comprising a leader and followers of the MAPC group; and
assigning a first AP of the MAPC group as the leader and remaining APs of the MAPC group as the followers.

16. The non-transitory computer readable medium of claim 15, wherein the MAPC modes comprises: Coordinated Spatial-Reuse (C-SR), a Coordinated Time-Division-Multiple-Access (C-TDMA), Coordinated Frequency-Division-Multiple-Access (C-FDMA), Coordinated Orthogonal-Frequency-Division-Multiple-Access (C-OFDMA), or a combination of two or more of C-SR, C-TDMA, C-FDMA, and C-OFDMA.

17. The non-transitory computer readable medium of claim 15, wherein discovering the MAPC modes comprises:
receiving a broadcast of discovery frames from each of the plurality of APs, the discovery frames comprising one or more MAPC modes supported by broadcasting AP.

18. The non-transitory computer readable medium of claim 15, further comprising:
setting the at least one common MAPC mode as a MAPC mode of communication for the MAPC group.

19. The non-transitory computer readable medium of claim 18, further comprising:
distributing, after setting the MAPC mode of communication for the MAPC group, timing for the MAPC group to each AP of the MAPC group.

20. The non-transitory computer readable medium of claim 18, further comprising:
assigning, after setting the MAPC mode of communication for the MAPC group, resources to each AP of the MAPC group.
